(19) United States
(12) Patent Application Publication
(10) Pub. No.: US 2013/0114066 A1
(43) Pub. Date: May 9, 2013

(54) SYSTEM AND METHOD OF IN SITU WIND TURBINE BLADE MONITORING

(71) Applicants: Priyavadan Mamidipudi, Bristow, VA (US); Elizabeth A. Dakin, Great Falls, VA (US); Frederick C. Belen, JR., Oak Hill, VA (US); Philip L. Rogers, Hume, VA (US)

(72) Inventors: Priyavadan Mamidipudi, Bristow, VA (US); Elizabeth A. Dakin, Great Falls, VA (US); Frederick C. Belen, JR., Oak Hill, VA (US); Philip L. Rogers, Hume, VA (US)

(73) Assignee: BLUESCOUT TECHNOLOGIES, INC., Chantilly, VA (US)

(21) Appl. No.: 13/620,711

(22) Filed: Sep. 15, 2012

Related U.S. Application Data
(63) Continuation of application No. 13/174,115, filed on Jun. 30, 2011.

(51) Int. Cl. F03D 11/00

(52) U.S. Cl. CPC F03D 11/0091
USPC 356/28; 356/27

(57) ABSTRACT

Systems and methods are disclosed for monitoring parameters such as the material properties or structural integrity of a wind turbine blade on a wind turbine. An example method comprises detecting light reflected from a wind turbine blade, generating a value based on the detecting, comparing the value to a threshold value and determining a parameter of the wind turbine blade based on the comparing. A further embodiment comprises determining a wind velocity by detecting reflected light from a target area in front of the wind turbine blade. An example system comprises a detector configured to detect light reflecting from a turbine blade and to produce a value representative of the detected light. The system also comprises a comparator configured to compare the value to a threshold value and to determine a parameter of the turbine blade.

### BACKGROUND

1. Field of Invention

This disclosure relates to systems and methods to monitor parameters, e.g., material properties and structural integrity, of wind turbine blades, for example during operation of a wind turbine.

2. Background Art

Wind turbines generate renewable energy through harnessing of wind energy. Wind turbine blades rotate through interaction with the wind to generate electrical power. Typically, wind conditions are continually changing. Thus, in order to generate a predictable and substantially constant power supply, and to maximize the conversion of wind energy to electrical energy, the operating parameters of the wind turbine must be continually monitored and/or adjusted.

Adaptive control of the wind turbine can be achieved using a turbine-mounted wind velocity sensor such as, for example, a laser Doppler velocimeter (“LDV”), the output of which informs a control system to govern the operation of the turbine. In response to an output of a wind velocity sensor, a wind turbine nacelle may be rotated into or out of alignment with the wind, thereby modifying the yaw of the turbine. The individual blades of the turbine may also be angled in response to the strength or speed of the wind, thus modifying the pitch of the turbine blades. Yaw and pitch control are crucial to the efficient and safe operation of a wind turbine.

Even under ideal operating conditions, however, wind tarbine blades eventually wear out and must be replaced. Typically, a wind turbine blade has a designated lifespan, assuming the blade is operated within certain parameters. If those parameters are exceeded (for example, the blade is subjected to excessive stress from severe wind gusts), the blade's actual lifespan may be reduced.

Failure of a turbine blade can cause significant damage and result in expensive repairs and downtime. Therefore it is important to replace worn out turbine blades before the blades fail. It may not be practical, however, to simply replace turbine blades at the end of a manufacturer's stated lifespan. The actual lifespan of a blade may in fact be shorter than the predicted lifespan depending on the actual wind conditions, and other weather conditions and environmental conditions, to which the turbines are exposed.

Existing approaches to monitoring the health of wind turbine blades include contact sensors (such as acoustic sensors), and fiber Bragg grating sensors embedded into the turbine blades, among others. Sensors placed in other locations, such as in a wind turbine gear box, have also been used. These approaches, however, are costly to manufacture and maintain and are subject to inaccuracies over time due to material degradation.

### SUMMARY

Therefore, what is needed is a remote non-contact system and method to continuously monitor the health of turbine blades such that real time information regarding the structural integrity, lifetime, level of fatigue, and time to failure can be known.

Systems and methods are disclosed for monitoring parameters such as the material properties or structural integrity of a wind turbine blade on a wind turbine. An example method comprises detecting light reflected from a wind turbine blade, generating a value based on the detecting, comparing the value to a threshold value and determining a parameter of the wind turbine blade based on the comparing. A further embodiment comprises determining a wind velocity by detecting reflected light from a target area in front of the wind turbine blade. An example system comprises a detector configured to detect light reflecting from a turbine blade and to produce a value representative of the detected light, and a comparator configured to compare the value to a threshold value and to determine a parameter of the turbine blade.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates a system for monitoring blade integrity and wind velocity for a wind turbine, according to an embodiment of the present invention.

FIG. 2 illustrates a system for measuring material integrity of a sample using an LDV.

FIGS. 3A-3D illustrate graphs showing material degradation as measured by systems and methods of disclosed embodiments.

FIG. 4 illustrates a method for assessing oncoming wind velocity and monitoring turbine blade integrity.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The present invention is directed to systems and methods of in situ wind turbine blade monitoring. This specification discloses one or more embodiments that incorporate the features of this invention. The disclosed embodiment(s) merely exemplify the invention. The scope of the invention is not limited to the disclosed embodiment(s). The invention is defined by the claims appended hereto.

Some of the disclosed embodiments serve the dual purpose of: (1) monitoring material properties and structural integrity of wind turbine blades, and (2) measuring wind velocity. Other embodiments can perform the functions of either (1) or (2) separately. Embodiments to measure wind velocity have been disclosed, for example, in U.S. Pat. No. 5,272,513, U.S. Patent Application Publication No. 2009-0142066 A1, and International Patent Application Publication No. WO 2009/134221. The entire disclosure of each of these documents is hereby incorporated by reference.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM; random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

In one embodiment a laser Doppler velocimeter (“LDV”) may be used to both determine oncoming wind velocities as well as to monitor the health of an operating wind turbine blade. An LDV system designed to provide real time wind speed and direction transmits light to a target region (e.g., into the atmosphere) and receives a portion of that light that is scattered or reflected back. In atmospheric measurements, the target for this reflection consists of entrained aerosols (resulting in Mie scattering) or the air molecules themselves (resulting in Rayleigh scattering). Using the received portion of scattered or reflected light, the LDV determines the velocity of the target relative to the LDV.

In greater detail, an LDV system designed to provide real time wind speed and direction includes a source of coherent light, a beam shaper and one or more optical elements (e.g., telescopes). The optical elements each project a generated beam of light into the target region. The beams strike airborne scatterers (or air molecules) in the target region, resulting in one or more back-reflected or backscattered beams. In a monostatic configuration, a portion of the backscattered beams is collected by the same optical elements that transmitted the beams. The received beams are combined with reference beams in order to detect a Doppler frequency shift from which velocity may be determined.

In addition to determining wind velocity, an LDV may be used to monitor the health of an operating wind turbine blade. A turbine-mounted LDV provides both adaptive control information (based on determined wind velocities) and is used to assess the health and remaining lifespan of each turbine blade on the wind turbine, as explained below.

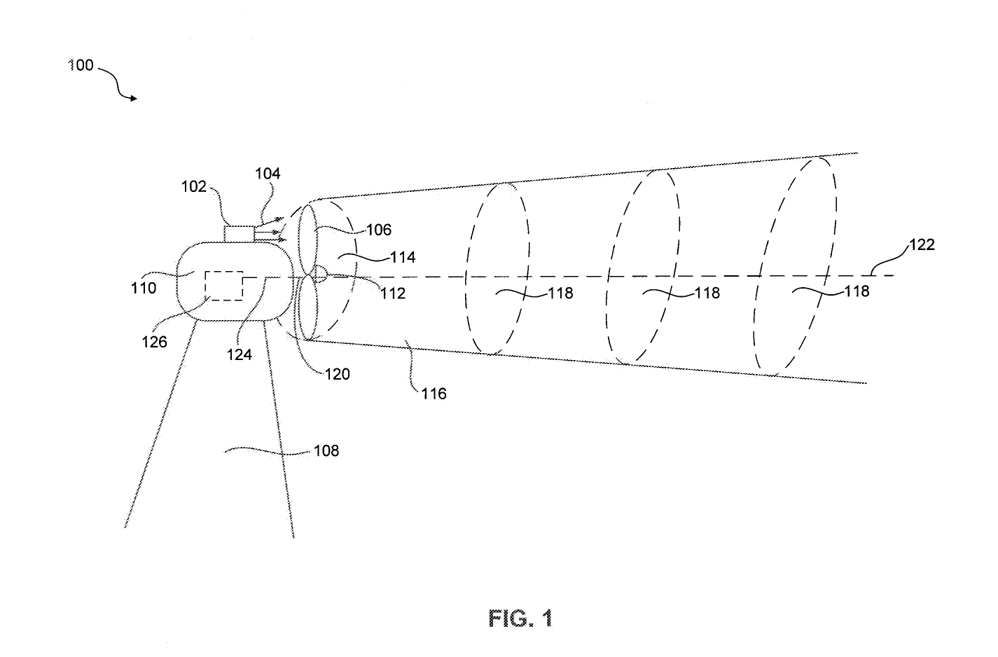

FIG. 1 illustrates a system 100, according to an embodiment of the present invention. In one example, system 100 comprises a wind turbine. Turbine 100 includes a tower 108, nacelle 110, a hub 112, blades 106, and sensor system 102.

In the example shown, nacelle 110 sits atop tower 108 and allows for horizontal rotation or yawing as well as pitching of turbine 100 so that turbine 100 aligns with a direction of the wind. Blades 106 and hub 112 are attached to nacelle 110 via an axle 120 and spin about a horizontal axis 122. Nacelle 110 contains a drive-train 124 and an electric generator 126, which do not spin with blades 106 and hub 112. The rotation of blades 106 encompasses a disc-shaped area or plane 114 that extends equally above, below and to the sides of nacelle 110. Accurate wind velocity measurements must therefore include measurements in an inflow region 116 in front of and including as much as possible of the disc-shaped area or plane 114. The measurements are preferably independent of each other and cover locations within the inflow region 116 with sufficient density.

In one example, sensor system 102 is a laser Doppler velocimeter (LDV). LDV 102 is mounted on nacelle 110 of the wind turbine 100. An example of an LDV that may be used as a turbine-mounted sensor is disclosed in U.S. Application Publication No. US 2011-0037970 (“the '970 publication”), the entirety of which is incorporated herein by reference. The LDV of the '970 application includes a plurality of transceiver optical elements (e.g., telescopes) that are remotely located from the LDV coherent light source.

In one example, LDV 102 includes three n=3 laser beams 104 oriented to take measurements along different beam paths 104. Other numbers of n beams may be used. Using the beam paths 104, measurements are made simultaneously at different target planes 118. The measurements at known angles to each other may be used to determine three-dimensional wind vectors of each of the target planes 118.

In this example, LDV 102 is mounted behind the blades 106, and beam paths 104 pass through plane 114. As a result, some laser pulses traveling along the measurement beams will pass unobstructed through the blade plane 114. These measurement beams arrive at the different target planes 118 and are then reflected back to the LDV 102 and are used to determine oncoming wind velocities. However, some pulses do not pass through the blade plane 114 without obstruction. Instead, these pulses strike one of the rotating blades 106 and are immediately reflected back to the LDV 102. In one embodiment of the present invention, the information received from the laser pulses that are reflected from the turbine blade 106 is used to monitor the health of the blade 106, as discussed in more detail below. Embodiments used to measure the material properties and structural integrity of a wind turbine blade may employ the same or a different number n of light beams.

In this example, a light beam, e.g., a laser pulse, such as that emitted by LDV 102, can be used to determine integrity of blade 106. When light is reflected from a surface of blade 106, characteristics or parameters of the surface may be determined. The reflected light can include information, e.g., a reflection signature, of the surface. For example, each surface has a different reflection signature dependent upon the material from which the surface is constructed and the state of the material. For example, a surface made of aluminum will generate a different signature than a surface made of a carbon-based polymer. Similarly, an unstressed surface made of a first material will generate a signature that differs from a stressed or fatigued surface made of the same material. The vibration spectrum of a material such as a wind turbine blade is an example of a reflection signature. A reflection signature, for example, can include the frequencies of vibration measured at a plurality of locations along the turbine blade. In general, reflection signatures change over time and such changes indicate changes in material properties. Examples, of measured signatures are discussed below.

In measuring the structural integrity of blade 106, measurements of the blade are made over a period of time and then compared with each other to identify changes in the reflection signature of the blade. For example, a database of known reflection signatures can be generated for turbine blades operating over time within their operating parameters.

In one example, a new turbine blade presents a unique reflection signature. When the blade has been operating for several months, the blade presents a different unique reflection signature. Near the end of its predicted lifespan, the blade again presents a different unique reflection signature. By making measurements of an operating turbine blade at various times in the blade's lifespan, reflection signatures representing the entire lifespan of the turbine blade can be collected and stored.

For example, a collection of reflection signatures for a blade represent a “reflection signature timeline” that corresponds to the lifespan of the blade. In one example, reflection signature timelines are collected for multiple turbine blades of the same make and model, and then an average reflection signature timeline is determined for the specific make and model. Measurements may also be made using different target areas on the measured surface, with an average reflection signature representing the measurements from the entire surface.

Once a reflection signature timeline is generated, the timeline is used for a baseline comparison with a specific reflection signature of a given turbine blade in operation. By matching the specific reflection signature with a corresponding signature on the timeline, an assessment may be made as to the integrity and remaining lifespan of the measured turbine blade.

For example, by determining where the reflection signature is on the timeline, a determination may be made of the percentage lifespan remaining for the measured blade. By combining the determined information with knowledge of when the blade entered operation, a prediction could be made of the blade's actual lifespan. An operator can be forewarned when a blade has only 50%, 25% or 10% of its useful lifespan remaining, for example. In addition to measuring the lifetime of a wind turbine blade due to normal wear and tear, reflection signatures can be monitored in real-time to indicate error events, damage, cracks, fatigue, etc.

Reflection signatures represent the specific vibration patterns (and any statistical information derived from the data) of the surface being measured. Most surfaces have complex vibration patterns. As a result, comparing vibration patterns in the time domain is a non-trivial task. For example, comparisons are more readily apparent in the frequency domain.

In the frequency domain, a fundamental frequency can be identified for a vibration pattern. From the fundamental frequency, higher-order harmonics may also be determined. By using higher-order harmonics of the fundamental frequency of the returned reflection signature, significant differences between signatures can be determined and meaningful comparisons can be made between a measured reflection signature and a reference signature on the timeline. In particular, in one example, a third harmonic seems to reliably show differences between reflection signatures. Thus, in this example, reflection signature timelines are stored and include higher-order harmonics of the measured reflection signatures.

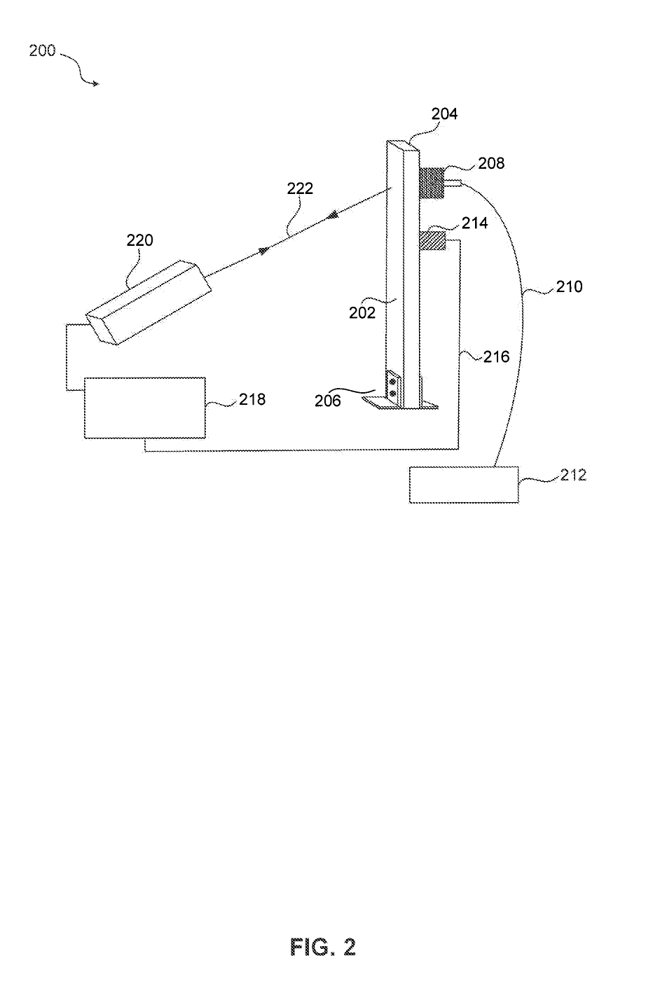

FIG. 2 illustrates a measuring system 200. For example, system 200 can be used to measure vibration signatures representing material degradation of an object or a surface of an object. System 200 includes an aluminum beam 202 that is clamped at one end 206 and has a free end 204, a mechanical actuator 208, a cable 210, a signal generator 212, an accelerometer 214, a cable 216, an analyzer 218, and a detecting system 220.

In one example, signal generator 212 and actuator 208 are used to introduce vibrations at a chosen frequency to beam 202. Actuator 208 and signal generator 212 are connected by cable 210. Accelerometer 214 is used to measure the resulting mechanical vibrations. Detector 220, e.g., an LDV, transmits and receives a laser beam 222 to reflect from beam 202. Detected signals from accelerometer 214 and LDV 220 are received by analyzer 218, e.g., an audio spectrum analyzer.

In one example, beam 202 can have dimensions of 31″×3″×4″. By striking the beam and using the spectrum analyzer 218, the fundamental frequency was measured to be 75.2 Hz. In a first series of measurements, the beam was driven by the actuator 208 at the fundamental frequency, and the resulting surface velocity was mapped along the length of the beam using LDV measurements. A vibration (node-antinode) pattern was thus obtained. As expected, the maximum displacement (anti-node) was observed at the top 204 of the beam, while no displacement (node) was obtained at the bottom 206 where the beam was clamped. The accuracy of the LDV measurements were confirmed by comparison with results of accelerometer 214 measurements. The beam was driven continuously at the fundamental frequency for a period of 100 hours and no discernible variation was observed in the vibration pattern.

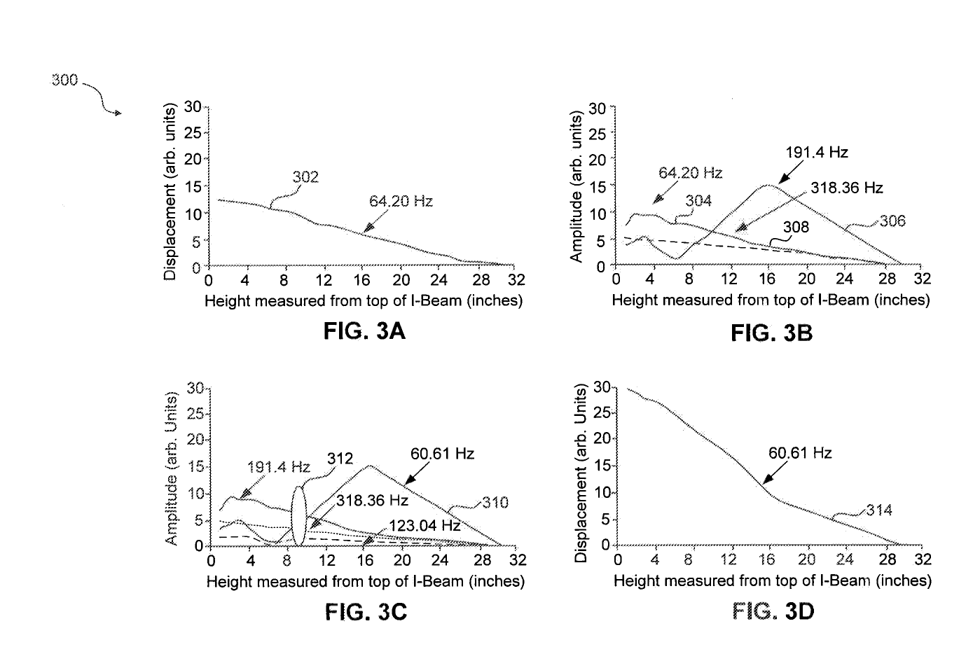

In order to simulate material degradation, a 2″ deep cut was introduced at the center of the beam. The presence of the cut resulted in a downshift of the resonance from 75.2 Hz to 64.2 Hz. In this example, beam 202 was driven continuously at the lower frequency and the vibration pattern was mapped every hour. FIG. 3A presents the measured vibration pattern 302 immediately after introduction of the cut. Vibration pattern 302 is consistent with a node at the clamped end of the beam (206 in FIG. 2) and an anti-node at the top of the beam (204 in FIG. 2).

FIG. 3B illustrates measured vibration patterns observed after a period of 60 hours. These vibrations include higher order modes 306 and 308 having frequencies 191.4 Hz and 318.4 Hz respectively. The measured vibration patterns 304, 306, and 308 also included a secondary node 6″ from the top of the beam. The appearance of the node indicated that the beam was vibrating about two distinct points.

FIG. 3C illustrates the vibration patterns 310 and 312 observed after 75 hours. In this example, the 64.2 Hz frequency, previously observed after 60 hours (304 in FIG. 3B) was replaced by two new frequencies: 60.6 and 123.0 Hz. The appearance of a lower fundamental frequency 60.6 Hz (310 in FIG. 3C) indicated a downward shift in the resonance frequency of the beam. In this example, such a downward shift in the resonance frequency indicates material degradation as discussed below.

FIG. 3D illustrates the vibration pattern 314 observed after 80 hours. In this example, only a single vibration frequency, 60.6 Hz, was observed. The vibration pattern 314 included a third node 8″ from the base of the beam. This third node along with the reduced resonant frequency (60.6) imply a further reduction in the free length of the beam. Inspection of the beam revealed that a crack initiated at the cut had physically propagated across the width of the beam. The change in vibration pattern illustrated in FIG. 3D corresponded to the onset of total failure of the beam. The vibration pattern physically exhibited two separate motions within the beam. One was an oscillation of the lower half of the beam and another was a separate oscillation of the upper part of the beam (above the cut).

In a further example, tests were carried out on an aluminum beam with dimensions of 48″×3″×4″. The beam was driven continuously for 100 hours at the measured fundamental frequency of 41.1 Hz. No significant change in the vibration pattern was observed. A 1.5″ cut was then introduced resulting in a lowering of the fundamental frequency to 31.3 Hz. The beam was then driven continuously for 190 hours. Measurements were periodically taken until total structural failure was observed. Details of the measurements on the second beam are summarized in Table 1.

TABLE 1

| Time | | Observed | | |
|---|---|---|---|---|
| elapsed | Resonant | Fre- | Location of | |
| since | Frequency | quencies | nodes and anti- | |
| cut | (Hz) | (Hz) | nodes | Comments |
| 0 hrs. | 31.3 | 31.3 | Anti-node at top | Single frequency |
| | | | Node at bottom | |
| 45 hrs. | 28.4 | 28.4 | Anti-node at top | Resonant frequency |
| | | | Node at bottom | shifts down. |
| 97 hrs | 27.4 | 27.4 | Anti-node at top | Resonant frequency |
| | | | Node at bottom | shifts down. |
| 118 hrs. | 25.3 | 25.3 | Anti-node at top | Resonant frequency |
| | | | Node at bottom | shifts down. |
| 140 hrs. | 25.3 | 25.3 | Anti-node at top | No change. |
| | | | Node at bottom | |
| 168 hrs. | 23.4 | 23.4 | Anti-node at top | Crack has |
| | | | Node at bottom | propagated past the |
| | | | | cut. |
| | | 45.9 | Anti-node at top | Higher order modes |
| | | | Node at 4″ mark | appear at 23.4 Hz, |
| | | | | 45.9 Hz, and |
| | | | | 70.1 Hz. |
| | | 70.1 | Anti-node at top | Resonant frequency |
| | | | Node at bottom | has stronger |
| | | | | amplitude. |
| | | | | Resonance |
| | | | | frequency shifts |
| | | | | down. |
| 172 hrs. | 23.4 | 23.4 | Node at 6″ mark | Crack has |
| | | | Anti-node at 24″ | propagated farther |
| | | | mark (at the cut) | into the beam. |
| | | 45.9 | Anti-node 6″ | Higher order modes |
| | | | from top | remain. |
| | | | Node at bottom | |
| | | 70.1 | Anti-node at top | Node-antinode |
| | | | Node at bottom | pattern has changed. |
| 175 hrs. | 23.4 | 23.4 | Anti-node at top | Crack has |
| | | | Node at bottom | propagated most of |
| | | | | the way across the |
| | | | | beam width. |
| | | | | Higher order modes |
| | | | | disappear. |
| 190 hrs. | 23.4 | 23.4 | Anti-node at top | The beam is on the |
| | | | Node at bottom | verge of breaking. |

The results presented in FIGS. 3A-3D and Table 1 confirm the notion that mechanical properties are correlated with vibrational properties that can be measured with an LDV. The term “reflection signature timeline” is used to denote the temporal progression of a parameter, e.g. material properties, that can be measured with an LDV.

The foregoing discussion demonstrates the notion of detecting light reflected from a material. In examples, the material can be a wind turbine blade. In examples, a value can be generated from the reflected light. The value can represent the measured vibrational properties of the material. The value can be the fundamental vibration frequency of the material. In further examples, the value can be one of the higher harmonic vibration frequencies.

The results of FIGS. 3A-3D and Table 1 also illustrate the notion determining a parameter for a material based on comparing a value to a threshold value. In examples, the parameter can be related to the material properties or structural integrity of the material. The parameter might be related to a lifetime of the material. The threshold value might be a resonant frequency shift corresponding to material degradation or material failure. The threshold value may be related to the presence or absence of higher vibrational harmonics.

The disclosed systems and method thus enable a real-time assessment of a parameter such as the mechanical properties or structural integrity of a material. In examples, the material properties and/or structural integrity of a wind turbine blade, can be obtained. In examples, reflection signature timelines can be measured and are stored in a database for different makes and models of wind turbine blades. For each make and model, a reflection signature timeline may be made available. Then, when a reflection signature of an operational wind turbine blade is obtained, its higher-order harmonic can be compared with the appropriate reflection signature timeline, thus allowing a determination of, for example, the percentage lifespan remaining for the measured blade.

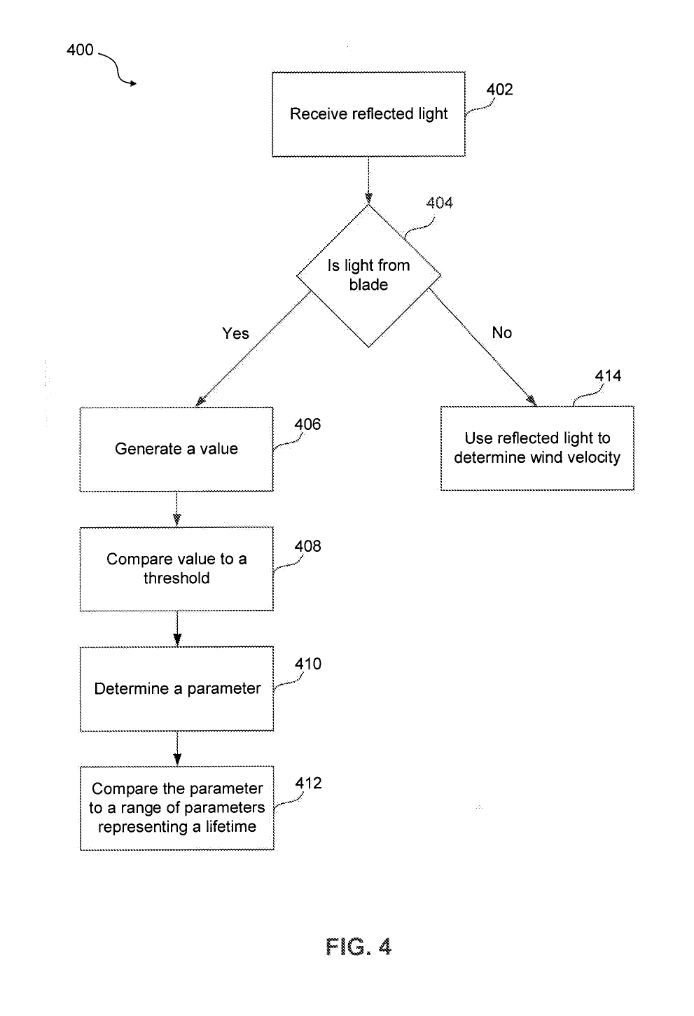

FIG. 4 depicts a flowchart illustrating a method 400, according to an embodiment of the present invention. For example, method 400 many be implemented by one or more of the systems shown in FIGS. 1 and 2. It is to be appreciated that in various embodiments, method 400 may not operate in the sequence shown or require all steps.

In one example, in step 402, reflected light is received. For example, an LDV mounted on a wind turbine nacelle receives light reflected from the turbine blades and target planes at various ranges in front of the wind turbine.

In step 404, a determination is made whether the reflected light is from an object or an environment surrounding the object. For example, a determination is made whether the light was reflected from a turbine blade or the air surrounding the turbine blade. The LDV determines whether a reflected pulse represents a reflection from an operating turbine blade or from a target plane at a predetermined distance in front of the turbine.

In step 414, if NO in step 404, the reflected light is used to determine parameters of the environment surrounding the object. For example, if the reflected pulse represents a reflection from a target plane, the reflected pulse is used to determine wind velocity. In one example, the pitch and yaw of the turbine may then be adjusted based on the measured wind velocity.

If YES in step 404, in step 406 a value is generated based on the reflected light. For example, if the reflected light represents a reflection from a turbine blade, the pulse is used to determine a value related to properties of the blade, such as degradation through time of the material.

In step 408, the generated value is compared to a threshold value. For example, the threshold can be based on a fundamental vibration frequency. In other examples, the threshold can be based on a higher harmonic vibration frequency. In still further examples, the threshold can be based on a ratio of two quantities: one being an amplitude of vibration at a higher harmonic frequency, the other being an amplitude of vibration at the fundamental frequency. The comparison can be done to determine a similarity or difference between the measured vibration properties the turbine blade and those of representative turbine blades with known mechanical properties.

In step 410, a parameter is determined based on the relationship between the value and the threshold value. For example, the parameter can represent a nominal age of a turbine blade.

In step 412, the parameter can be compared to a range of parameters. For example, the range of parameters can represent a lifetime of the wind turbine blade.

If a wind turbine includes multiple blades, processing may also be performed to identify the specific blade associated with a received reflection. Correct associations can be performed by comparing a received reflection with previously received reflection signatures (including measurements taken during an installation or non-operational time). This allows association of a received reflection signature with the blade most likely to produce a similar reflection signature. Correct associations can also be performed by combining the received reflection signature data with operational data indicating the positions of the turbine blades at the time the reflection signature is received.

In further examples, processing and storage can be performed by a computing device that is communicably coupled to the LDV, either as part of the LDV or remotely located from the LDV. The computing device can also store a predefined threshold percentage of lifespan that is set for each blade make or model so that replacement of the corresponding blade may be triggered. For example, one may choose to set replacement at 10% remaining lifespan for a given blade make and model. If blade health is below a predetermined threshold, an alarm or warning message can be generated. In this way, the blade can be replaced during a scheduled maintenance downtime instead of as an emergency procedure.

Multiple thresholds may be defined. For example, one threshold may pertain to degradation based on normal wear and tear. Another threshold, for example, might pertain to changes indicating a damage event the can lead to near-term or imminent failure. A range of parameter tolerances may also be defined to characterize the health of a turbine blade based on statistics. These may be used to generate an output that can indicate to an operator that the state of the blade is within one of several categories such as “green,” “yellow,” and “red” to indicate, for example, “good,” “fair,” and “poor,” blade health respectively.

While embodiments of the invention have been described in relation to wind turbines, the use of LDVs for both wind measurement and determination of blade integrity is not limited to only wind turbines. An LDV may be used in the manner described for determining the structural integrity of any object including, for example, propeller engines on planes and helicopters.

By using embodiments to measure both wind velocity and wind turbine blade health, engineers may be enabled to make better design decisions to maximize the wind energy conversion of a wind farm as a whole. For example, the positioning of individual wind turbines in the wind farm in turn affects the wind flow to other turbines in the farm. The wind flow, in turn, affects the energy production as well as wear and tear on individual turbines. In principle, through real-time monitoring of wind velocity and wind turbine blade health, the problems of energy conversion and longevity can be simultaneously optimized.

The Summary and Abstract sections may set forth one or more but not all exemplary embodiments of the present invention as contemplated by the inventors and are thus not intended to limit the present invention and appended claims in any way.

Various embodiments have been described above with the aid of functional building blocks illustrating the implementation of specific features and relationships thereof. The boundaries of these functional building blocks have been arbitrarily defined herein for the convenience of the description. Alternate boundaries can be defined so long as specific functions and relationships thereof are appropriately performed. The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above described exemplary embodiments.

1.-18. (canceled)

19. A method comprising:
receiving at a laser Doppler velocimeter at least a portion of light transmitted to a blade of a wind turbine as reflected light;
calculating a reflection signature of the blade based on the reflected light received at the laser Doppler velocimeter; and
determining a wellness indicator of the blade based on a comparison of the reflection signature of the blade with a plurality of stored reflection signatures.

20. The method of claim 19, further comprising determining that the wellness indicator satisfies a threshold value; and indicating that the blade should be replaced.

21. The method of claim 19, wherein the laser Doppler velocimeter is located on a nacelle of the wind turbine.

22. The method of claim 19, wherein the plurality of reflection signatures correspond to reflection signatures of a material that is the same as the material of the blade of the wind turbine.

23. The method of claim 19, wherein the reflection signature represents a vibration pattern of the blade.

24. The method of claim 19, further comprising a laser Doppler velocimeter located on a nacelle of the wind turbine.

25. The method of claim 19, further comprising transmitting the light from the laser Doppler velocimeter to the blade of the wind turbine.

26. The method of claim 25, wherein the laser Doppler velocimeter transmits the light during operation of the wind turbine.

27. The method of claim 19, wherein the reflection signature comprises a fundamental frequency.

28. The method of claim 27, wherein the reflection signature comprises higher order harmonics of the fundamental frequency.

29. The method of claim 27, wherein the reflection signature comprises a third harmonic of the fundamental frequency.

30. The method of claim 19, further comprising determining a remaining lifespan of the blade.

31. The method of claim 30, wherein the remaining lifespan of the blade is further determined based on a type of material used to construct the blade.

32. A system comprising:
a machine-readable storage medium comprising a plurality of reflection signatures;
a light detector configured to detect light reflected from a blade of a wind turbine;
a computing device configured to calculate a reflection signature of the blade based on the light reflected from the blade and determine a wellness indicator of the blade based on a comparison of the reflection signature of the blade with the plurality of reflection signatures stored in the machine-readable storage medium.

33. The system of claim 32, wherein the wellness indicator of the blade is further determined based on a type of material used to construct the blade.

34. The system of claim 32, wherein the plurality of reflection signatures correspond to reflection signatures of a material that is the same as the material of the blade of the wind turbine.

35. The system of claim 32, wherein the reflection signature represents a vibration pattern of the blade.

36. The system of claim 32, further comprising a light transmitter configured to transmit the light to the blade of the wind turbine.

37. The system of claim 36, wherein the light transmitter transmits the light during operation of the wind turbine.

38. The system of claim 32, wherein the reflection signature comprises a fundamental frequency.

39. The system of claim 38, wherein the reflection signature comprises higher order harmonics of the fundamental frequency.

40. The system of claim 38, wherein the reflection signature comprises a third harmonic of the fundamental frequency.

41. A method comprising:
receiving at a laser Doppler velocimeter at least a portion of light transmitted to a blade of a wind turbine as reflected light;
calculating a reflection signature of the blade based on the reflected light received at the laser Doppler velocimeter; and
identifying a structural change of the blade based on an identified change in the reflection signature of the blade.

42. The method of claim 41, wherein the structural change comprises at least one of damage to the blade, a crack in the blade, and blade fatigue.
